(19) United States
(12) Patent Application Publication
(10) Pub. No.: US 2012/0021392 A1
(43) Pub. Date: Jan. 26, 2012

(54) LIFE SKILLS TOOL KIT AND METHOD

(76) Inventor: JERI D. BOCK, Santa Barbara, CA (US)

(21) Appl. No.: 13/188,457

(22) Filed: Jul. 21, 2011

Related U.S. Application Data
(60) Provisional application No. 61/366,515, filed on Jul. 21, 2010.

(51) Int. Cl. G09B 19/00

(52) U.S. Cl. 434/238

(57) ABSTRACT

The Life Skills Tool Kit is a series of twelve key life skills in a multimedia format. Designed to convey life skills development information from a caregiver to a young child, in order for the child to listen, learn, practice and own positive habits and winning behaviors. Each life skill in the series contains a; DVD, coloring sheet, recognition sticker, reward card, practice board(s), reminder poster, and instruction sheets (with twelve indicia characters). The digital content is age appropriate information in digital storybook format which features puppets, animation and music. This evidenced based Life Skills Tool Kit is a unique learning method.

### RELATED APPLICATIONS

This application claims the benefit under 35 U.S.C. §119 of U.S. Provisional application No. 61/366,515 filed on Jun. 21, 2010.

### FIELD OF THE INVENTION

The present invention is directed to methods and systems for creating a new habit or behavior for young children using multi-media.

### BACKGROUND OF THE INVENTION

Psychologists and educators often struggle helping young children to develop good habits and positive behaviors. Four to eight year olds are just starting to learn social skills and how to deal with life's challenges, and giving children positive knowledge and tools to use during this critical development is essential. Learned disciplines compliments school learning in a positive way. It is not only helpful, but these skills will be used over a lifetime.

Most discipline programs (habits and behaviors) for children define habits, behaviors or things not to do. “Don't touch, stop yelling, calm down, etc.,” and has a set of consequences the child “earns”, i.e. “time-out”, “go to your room”, or yelling (or spanking) at the child until he/she stops. Most discipline systems communicate a reward/punishment style.

For instance, U.S. Pat. No. 7,699,614 issued Apr. 20, 2010 to K. L. Thurman, discloses a method for a behavior shaping kit includes at least one time-out defining device, at least one timer, a plurality of stickers having prohibitory indicia marked thereon, training devices for a caregiver, a plurality of stop signs, and craft tools. The caregiver affixes stickers having prohibitory indicia marked thereon to items in the house with which the child should not come into contact. When a child does come into contact with these items, the child is immediately placed in a time-out area which is defined by a time-out defining device. A time-out defining device serves to restrict movement of the child from place to place.

Other methods to teach children discipline involve tracking their performances (behavior monitoring and modification). Some of these patents relating to behavior monitoring and modification are described below.

U.S. Pat. No. 5,954,512, issued Sep. 21, 1999 to D. Fruge, discloses a behavior tracking board provides for the recording and monitoring of the general behavior of individuals. The board is particularly well suited for use in families having one or more small children, where it may be used to monitor their behavior over a predetermined period of time (e.g., one week) for the determination of rewards or punishment based upon the behavior for that period.

U.S. Pat. No. 5,697,790, issued Dec. 16, 1997 to A. Garland, discloses a method for a caregiver to teach discipline to a child involves the caregiver selecting a plurality of tokens in response to misbehavior of the child and instructing the child of a suitable token phrase relating to the misbehavior. The child places at least one of the tokens into a first portable container and repeats the token phrase. The child repeats the act of placing the tokens and repeating the token phrase a plurality of times.

U.S. Pat. No. 5,573,405, issued Nov. 12, 1996 to S. Evans, discloses behavior monitoring and training device, includes a board having a plurality of pegs extending from its front face. The pegs are arranged in a predetermined pattern such as a grid of rows and columns. Indicator plates can be marked with visual indicia representing individuals, task, behaviors.

U.S. Pat. No. 5,573,404, issued Nov. 12, 1996 to W. Stawski, II discloses a behavior modification device and process comprises a recording implement having a group of interrelated columnar items of a person's behavior, with an assigned monetary value to each of these. The columns are laterally and vertically aligned so that the person has a running view of a summary of the effect of his behavior during a stated period. The device is constructed as a sheet of printable paper or plastic material secured in place by magnetic attachment to a refrigerator door, or to some similar available surface where the family traffic is relatively dense. The device, when completed for the stated period, can be used as a basis for the payment of allowances.

U.S. Pat. No. 5,387,107, issued Feb. 7, 1995 to L. Gunter, et. al discloses a personalized interactive storybook and method of teaching a reader a desired behavioral pattern.

U.S. Pat. No. 5,470,235, issued Nov. 28, 1995 to S. Papaleo involves a child behavior improvement system that comprises a support member having a plurality of receptacles for receiving indicia of a reward, multiple discs having indicia defining a reward positioned in each of the receptacles, a cover for covering each receptacle, the cover being at least partially removable for providing access to the reward, and selectable indicia for positioning on the cover for identifying a desirable behavior goal.

U.S. Pat. No. 4,741,701, issued May 3, 1988 to S. Kossor discloses a behavior monitoring and status reporting device has indicator to show the current status of the child's behavior as the child completes each of a series of objectives.

U.S. Pat. No. 2,965,978, issued Dec. 27, 1960 to H. M. Olson relates to a job performance board, and more particularly to a job performance board which is particularly useful in teaching children to carry out a daily routine tasks.

What would be desirable is to take these traditional forms of disciplines utilized by caregivers and turn them on their head by giving the power to the child to change his/her action, in order to help him/herself; thus evoking the biblical parable of teaching a man to fish.

U.S. Pat. No. 5,451,163 issued Sep. 19, 1995 to Joseph R. Black shows a method of teaching reading in which symbols to be read are presented to the student. A minor image of a reader reading the symbols is presented to aid the student's understanding of visible reading correlations. The method may be presented using electronic devices, such as a video tape recorder and a monitor, or using a “transparent flash card” in which a piece of transparent material has a display of symbols to be read and an area for viewing the reader and teacher. The Black patent explains:
The use of a video medium to aid the instruction of language has been used for many years. The video medium offers several advantages over personal teaching within the classroom. Production costs which would be prohibitive if used for a single lesson can be absorbed by a large number of homes and classrooms. Also, electronic video systems provide the ability to repeat programs as often as necessary to aid the development of slow learners.
“Sesame Street”, a Public Television series, was an early developer in the field of video reading. By relating words to pictures, Sesame Street is able to teach language while maintaining the child's interest.
U.S. Pat. No. 4,636,173 to Mossman improves on the Sesame Street concept of teaching reading. The Mossman patent describes a method whereby words and syllables are highlighted on the screen to enhance the student's learning.
However, both Sesame Street and the Mossman patent do not maximize the potential of the video medium in teaching language. Reading phonics requires the interrelation of three separate areas: written words, human brain and face. Within these areas, three actions must occur in the correct sequence for a person to learn to read aloud accurately. First, the person must recognize the beginning of the words or phrase and the proper direction of reading. Second, the person must understand the proper pronunciation of the phonograms comprising the words or phrases. Third, the person must be able to pronounce the correct sounds.

What is needed is a method for creating a new habit or behavior (life skills) for young children using multi-media that does not teach reading or phonics.

### SUMMARY OF THE INVENTION

The present invention is directed to methods and systems for creating a new habit or behavior for young children using multi-media. The educational multi-media method along with its associated printed materials for conveying life skills development information from a caregiver to a child, to listen, learn, practice and own new habits and behaviors. Life skills as used herein refers to a set of human skills acquired via teaching or direct experience that are used to handle problems and questions commonly encountered in daily human life. The title of the application—Life Skills Tool Kit—goes beyond the traditional listen and learn programs and includes “practice” and “own” exercises. Measured success is recorded as the child's ownership of the new habit/life skill.

The preferred embodiment is an educational multi-media method along with its associated printed materials for conveying life skills development information from a caregiver to a child to listen, learn, practice and own new habits and behaviors. The Life Skills Tool Kit series comes in twelve parts and includes all of the necessary materials (age appropriate) a plurality of DVDs (stories, exercises, music), coloring sheets, recognition stickers, reward cards, practice boards, reminder posters and instruction sheets (with indicia of characters) on how to teach young children to listen, learn, practice and own these specific life skills.

The DVD's digital content information is age appropriate and in a storybook format. Features include storytellers (voice over), puppets and limited animation with practice and own exercise and reinforcing music video.

A caregiver shows a child the first story from the series of twelve DVDs. For example, the first life skill in The Life Skills Tool Kit series is related to stress relief and self-control (prototyped as the Catch a Breath program/kit) (How Billy Belly Got His Name). After the caregiver plays the first story for the child he/she rewards them with recognition stickers for listening to the story, doing the practice exercise and listening to the music. Coloring sheets of each puppet character are colored to reinforce the story. That same day the caregiver posts the reminder poster where the child can easily see it, to be reminded to use their new learned skill. The next day the child is asked how he/she used his/her new life skill and is recognized with another sticker. On the third day a recognition sticker is given to the child along with a reward card. These same steps are repeated for the rest of the life skills in the series.

The program teaches young children 4 to 8 years old, how to own these critical life skills when they are starting to develop new habits, behaviors and life skills.

A further understanding of the nature and advantages of the invention will become apparent by reference to the remaining portions of the specification and drawings.

### BRIEF DESCRIPTION OF THE DRAWINGS

Features and advantages of the present invention will become appreciated as the same become better understood with reference to the specification, claims, and appended drawings wherein:

FIG. 1 is a front view of a DVD, (digital content) first in the series stress and self-control (titled, How Billy Belly Got His Name);

FIG. 2 is front view of a coloring sheet, (indicia character Billy Belly);

FIG. 3 is a front view of front view of recognition sticker, (indicia character Billy Belly);

FIG. 4 is a front and back view of a reward card, (indicia character Billy Belly);

FIG. 5 is a front view of a reminder poster, (indicia character Billy Belly);

FIG. 6 is a front view of practice board A, (in 100 children kit);

FIG. 7 is a front view of practice board B, space for three to six days remember board check off;

FIG. 8 is a front view of instruction sheet 1;

FIG. 9 is a front view of instruction sheet 2;

FIG. 10 is a front view of the boxed The Life Skills Tool Kit; a DVD, a coloring sheet, a recognition sticker, a reward card, practice boards A and B, and a reminder poster, each with indicia of related character images. Kit is pre-packaged for 4 groups of 25 students (100 children);

FIG. 11 is a back view of boxed The Life Skills Tool Kit package, (100 children);

FIG. 12 is a front view of The Life Skills Tool Kit; a DVD, a coloring sheet, a recognition sticker, a reward card, practice board B, and a reminder poster, each with indicia of related character images; package 1 per child for at home usage; and

FIG. 13 is a back view of The Life Skills Tool Kit package 1 per child for at home usage.

### DETAILED DESCRIPTION OF THE PREFERRED EMBODIMENTS

The present disclosure relates generally to a system and method referred to as The Life Skills Tool Kit series, which focuses on giving children certain information and asking them to not only listen and learn, but more importantly the tools to practice and own their new learned life skills (The true reward comes from the child using his/her new life skill.)

The Life Skills Tool Kit comes packaged for 1 or 100 children. A practice board is for large groups only. The first one in this series is related to stress relief and self-control (prototyped as the Catch a Breath program/kit) (How Billy Belly Got His Name). It includes a DVD, a plural of coloring sheets, recognition stickers, reward cards, practice boards, reminder posters and instruction sheets, each with indicia of related character images (from the stories). The DVD's digital content information is age appropriate and in a storybook format. Features include storytellers (voice over), puppets and limited animation with practice and own exercise and reinforcing music video. This digital content is available on other digital platforms, such as streaming to a computer or television, mobile telephones or other like items. A caregiver shows children the story, exercise and music video from the series and explains the breathing exercise on how to self regulate per the story. (Per the instructions the caregiver repeats showing the exercise and music to the child/children until the child/children can repeat how to do the exercise for themselves. (Note: Singing the song from the music allows the child/children to learn the exercise quicker.)

The caregiver chooses whether he/she wishes to write down all names of the children participating, (referring to a large group, i.e. classroom setting) to show progress on the practice board A, or instead use practice board B, and just make three check marks for asking the children about their usage for three days.

After the caregiver plays the first story for the child he/she then rewards him/her with a recognition sticker for listening to the story, exercise and music. A coloring sheet is handed out to child/children for coloring of the puppet character (further reinforcing the story.) That same day the caregiver posts the reminder poster, practice board (A or B) as well as the colorings the child/children did, where the child/children can easily see them to be reminded to use their new learned skill. The next day each child is asked how he/she used his/her new life skill (asked out loud, verbally) and is recognized with another sticker. On the third day recognition sticker and reward card are given to child/children that showed knowledge of how to do the exercise. These same steps are repeated for the others in the series of The Life Skills Tool Kit.

Listen, Learn, Practice and Own are key ingredients in The Life Skills Tool Kit series learning methods, techniques and systems to help young children (4 to 8 years old) deal with core feelings and develop positive habits and behaviors.

Listen: Digital Content (available on all digital platforms) must be no longer than 9 minutes in duration (match attention span of young children) per life skill Friendly, non-threatening barnyard animals (puppets) make the emotional connection. These puppets are key spokespeople and act as message champions to build a “trust” mentor relationship. Storyline and music is age appropriate and has proper emotional tone, mood and pacing, resulting in a positive emotional reaction.

Learn: Plug and Play, 30 minutes max learning session. 9 minutes of video followed by questions and answers, and replaying the exercise and music per instructions. Targeted animation draws attention to key learning messages. Attention grapping “Pop Ups” via the character are integrated in the story line with sounds and movement this helps children focus on key learning moments. Minimum of 7 learning moments per session, underscored by puppets. Repetition key part of engaging, motivating and interacting with children. No less than six repetitions of key learning message. Core issues and concerns are dealt with in story content so that the child learns how important it is to be in control.

Practice: Practice sessions that motivate and inspire are the key part of the learning process. Children understand the emotions they feel when faced with challenges or concerns. Words alone are not the key to learning with this age group, especially 4 to 6 year olds. The compelling story line and puppets identify feelings, issues or concerns with solutions young children understand by matching their emotions to positive outcomes. Music is also used to underscore practice sessions.

Own: Each practice session has specially designed incentives and rewards. These key triggers inspire and recognize the positive learning process. Practice by doing, leads to ownership of targeted life skill.

Recognition is a core part of the program. The rewards help self-esteem by recognizing accomplishments which underscore individual success. Each child in the life skills program is recognized and appreciated in a positive way the child feels better, listens better and is motivated to cooperate.

Evidenced Based—Practice boards (Score boards) identify and recognize success and most importantly identify children not using the learning tools they are easily identified for further instructions.

In summary, twelve key (must know) life skill programs will be taught, each program in The Life Skills Tool Kit series follows the same protocol (with an eventual goal of forty-five life skills available in all languages). The twelve key life skill programs are: Stress and Self control (2), Building Self-Esteem, Following Directions, Getting Along, Friendship, Respect, Bullying and Teasing, Making Good Choices, Sharing and Caring, Diet and Exercise, and Anger. The life skill programs are skills all children should own so that they can deal with life's challenges and reach their full potential.

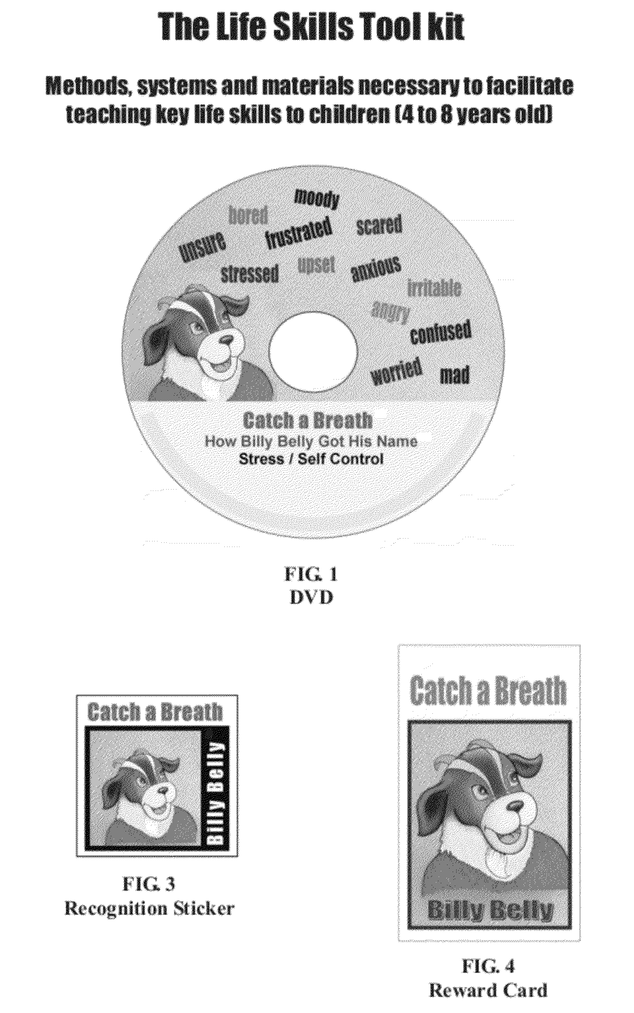

FIG. 1 is a front view of a DVD (How Billy Belly Got His Name); contains the story, practice exercise and music video for children to listen, learn, practice and own new life skill.

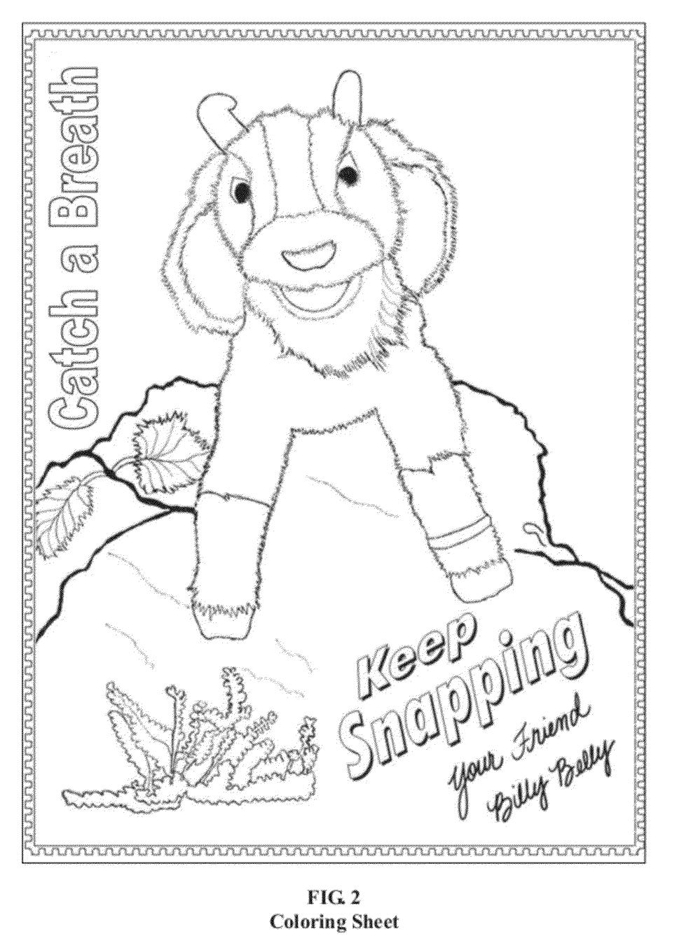

FIG. 2 is front view of a coloring sheet, (indicia character Billy Belly); children color with crayons on the black and white sheet to reinforce what he/she just learned from the DVD and gives them time to settle in their minds the skill they just learned. The sheet is desirably made from recycled paper 8½×11 inches, with black print. Each coloring sheet can be hung in the classroom (or home environment on a refrigerator or child's bedroom door) for further display and reinforcement.

FIG. 3 is a front view of front view of recognition sticker (indicia character Billy Belly) given to all children who watched the story, and practiced the exercise. Easy to peel from children's clothing; size 2×2 inches, full color.

FIG. 4 is a front view (of a double sided) reward card, (indicia character Billy Belly); given to all children who showed they mastered the technique taught in the life skill story's exercise shown (collectable). Size 2×3½ inches, full color, printed on card stock.

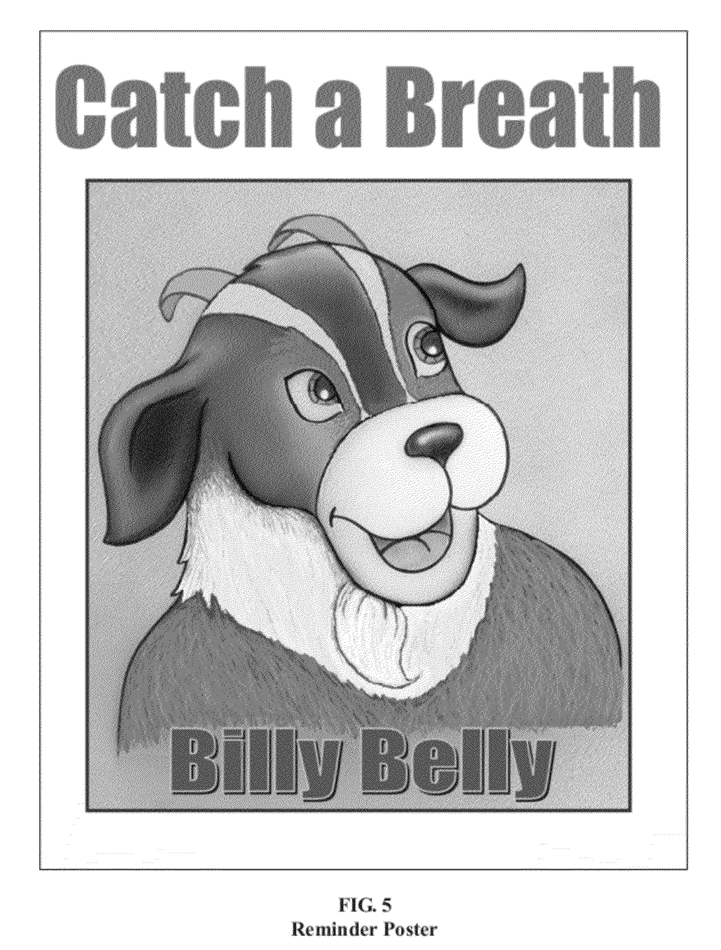

FIG. 5 is a front view of a reminder poster, (indicia character Billy Belly); teacher/caregiver places on a door as a visual reminder to the children to use what they have learned. Sized 8½×11 inches, full color, printed on card stock.

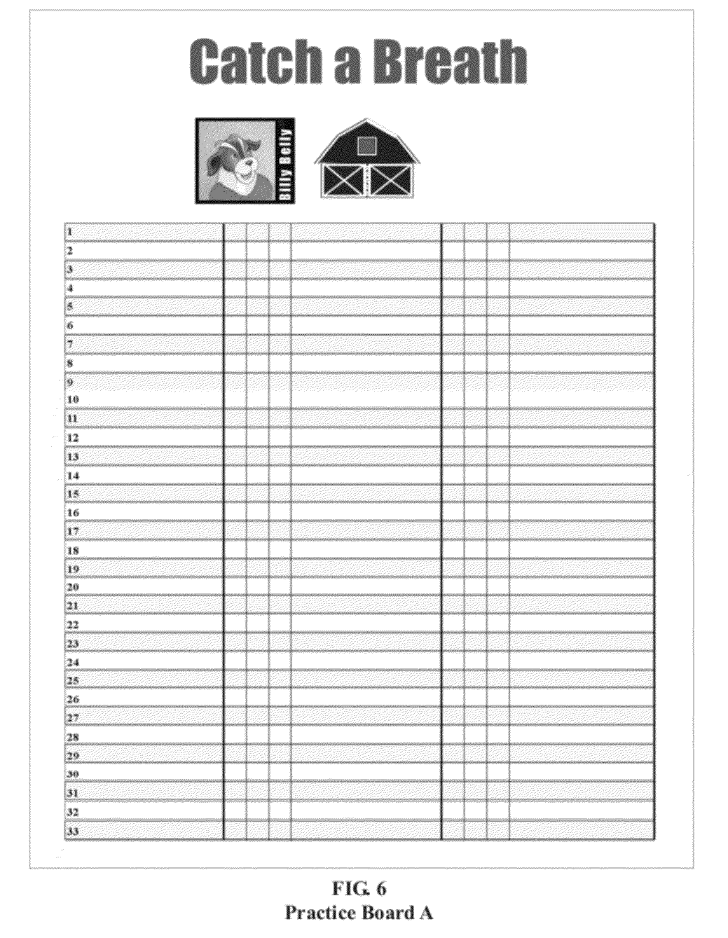

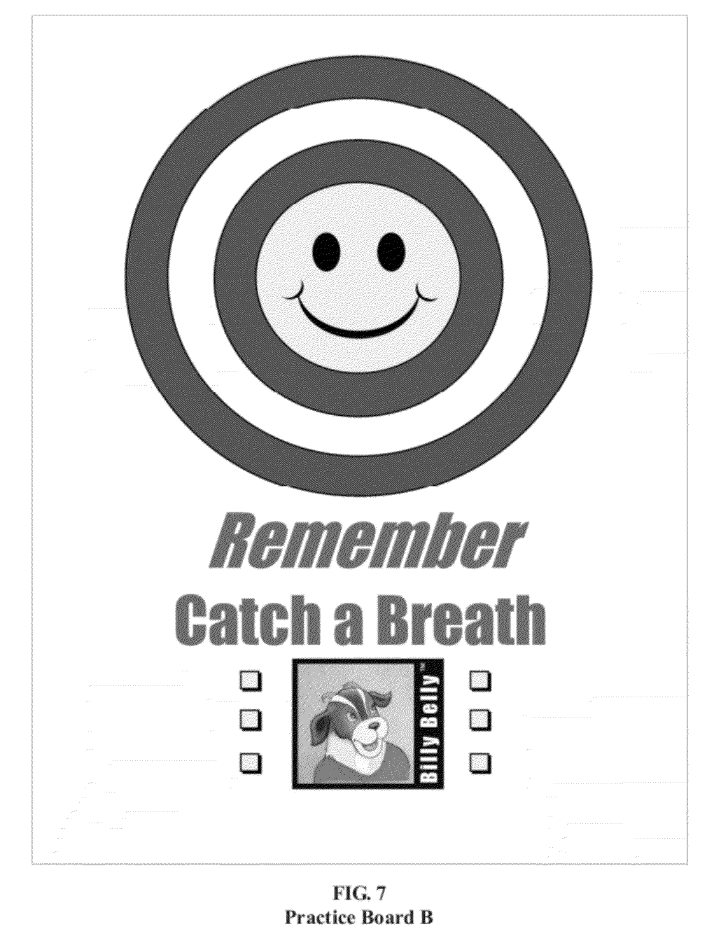

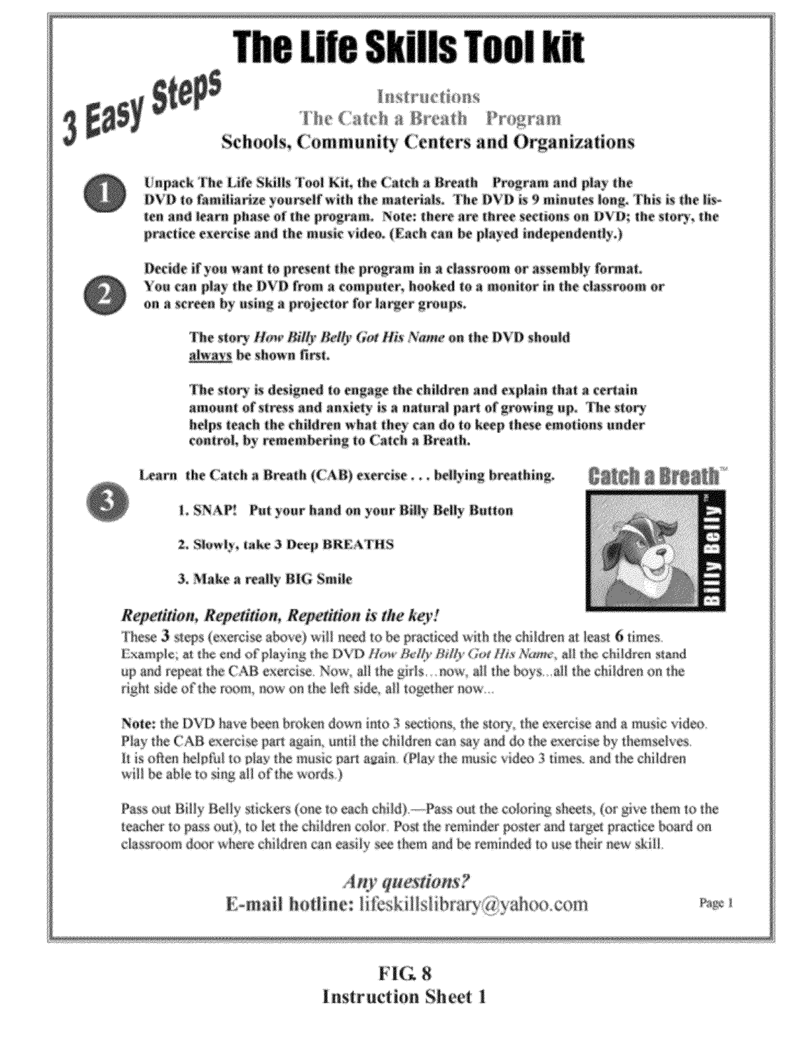

FIG. 6 is a front view of practice board A; (in the kit for 100 children) space to write all children's names participating in program; a useful tool for the teacher/caregiver to make notations to which children took place in the life skill program; more importantly can follow up with children that may need to see the DVD again to practice and own new life skill Sized 8½×11 inches, full color, printed on card stock.

FIG. 7 is a front view of practice board B; check mark area for three to six days; a useful tool “visual aide” for the caregiver to show children follow through, and to ask children how they used their new life skill; Size 8½×11 inches, full color, printed on card stock.

FIG. 8 is a front view of instruction sheet 1 (page 1); Simple, easy to apply learning process, plug and play, plus practice steps and measured results.

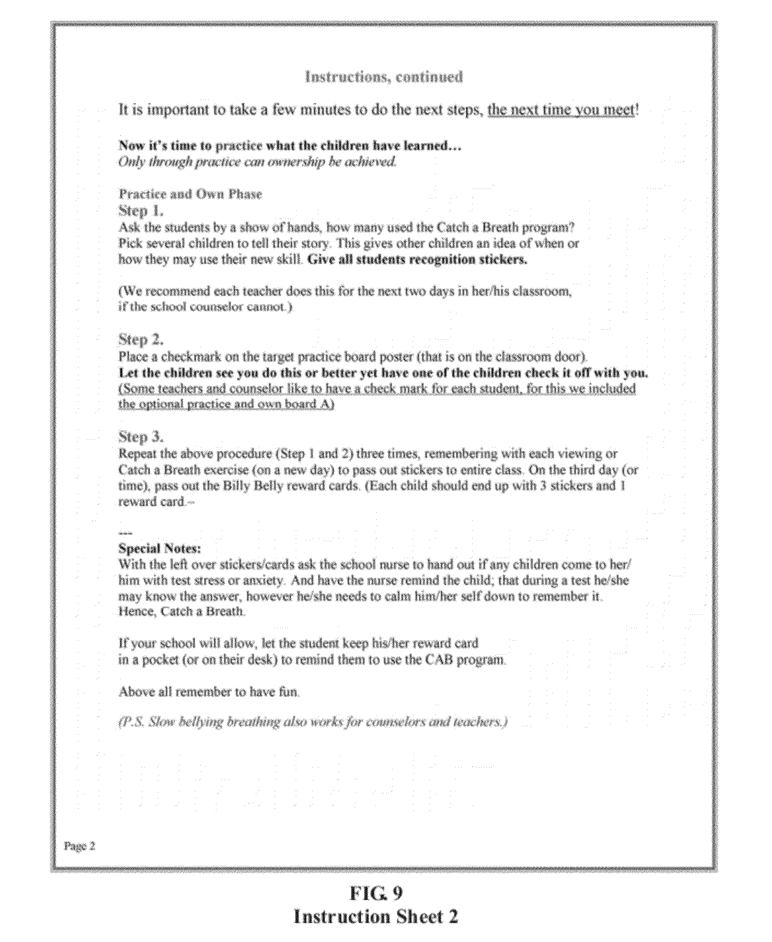

FIG. 9 is a front view of instruction sheet 2 (page 2);

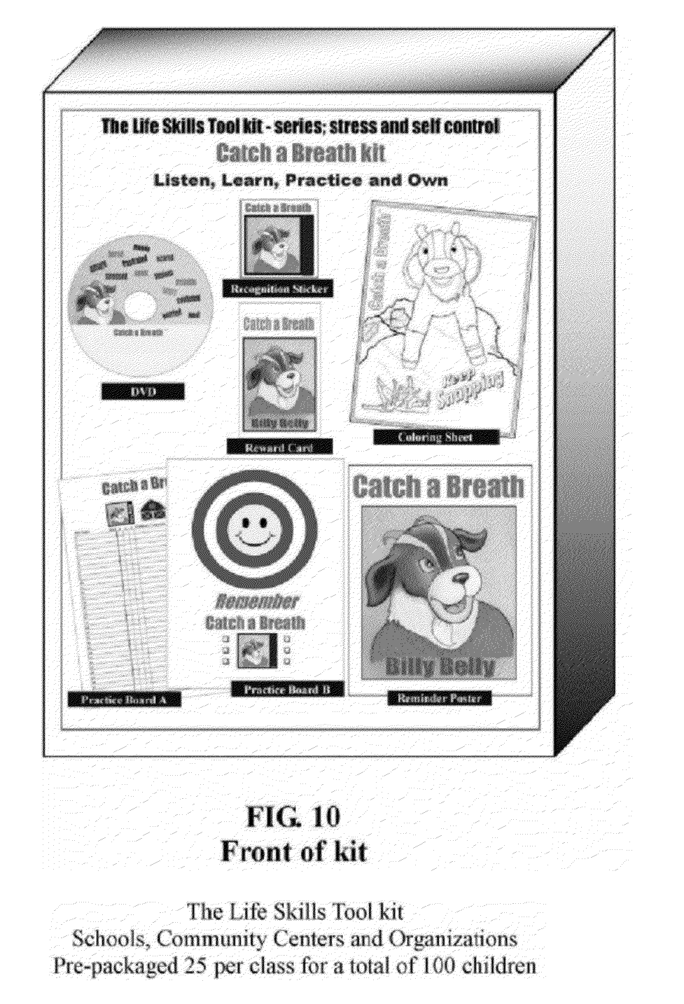

FIG. 10 is a front view of boxed The Life Skills Tool Kit—100. The first one in a twelve part series is related to stress relief and self-control (prototyped as the Catch a Breath program/kit). It includes a DVD (How Billy Belly Got His Name), a plural of coloring sheets, recognition stickers, reward cards, practice boards A and B, and reminder posters, each with indicia of related character images. Kit is pre-packaged for 4 groups of 25 students (100 children) for schools, community centers and organization's classroom environment; Packaging: Specially designed to reduce shipping cost of enclosed presorted learning materials.

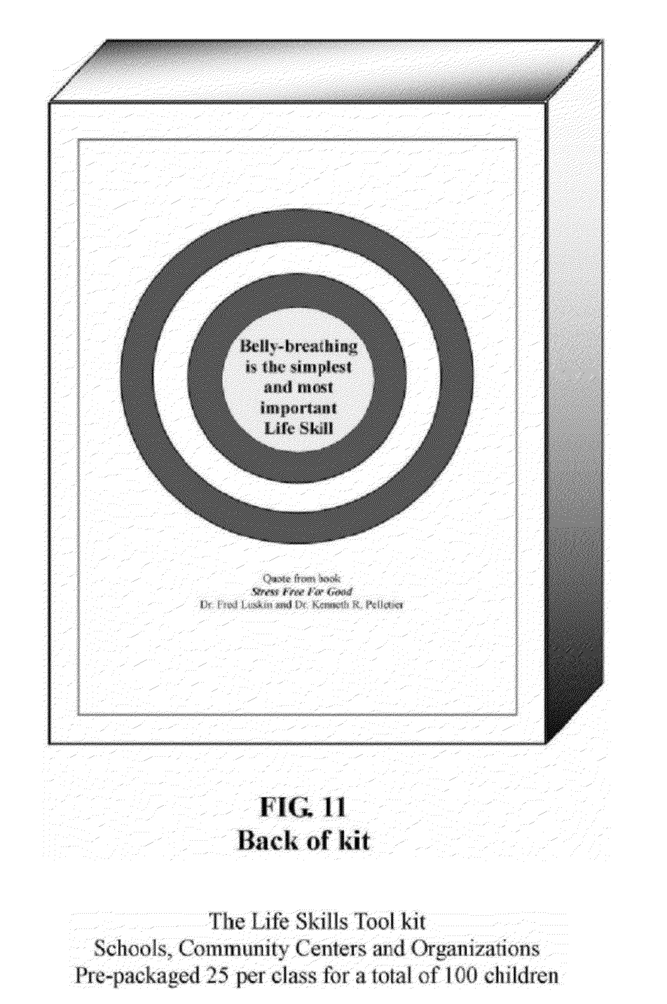

FIG. 11 is a back view of boxed kit package, per 100 children; quote from book Stress Free For Good by Dr. Fred Luskin and Dr. Kenneth R. Pelletier.

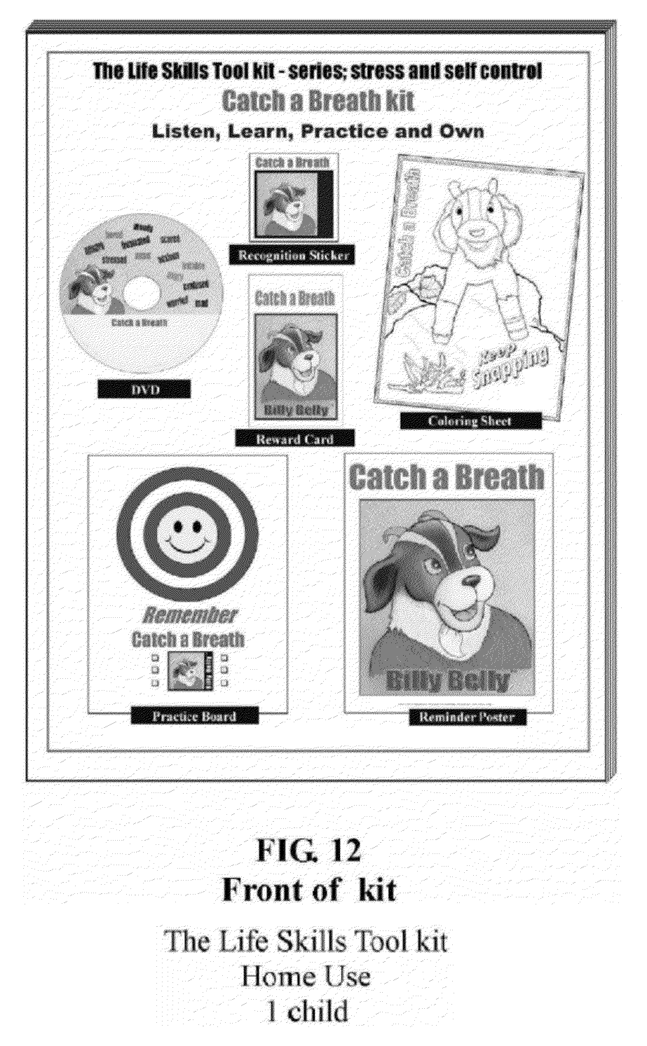

FIG. 12 is a front view of The Life Skills Tool Kit; a DVD, a coloring sheet, a recognition sticker, a reward card, practice board B, and a reminder poster, each with indicia of related character images, packaged one per child for at home usage.

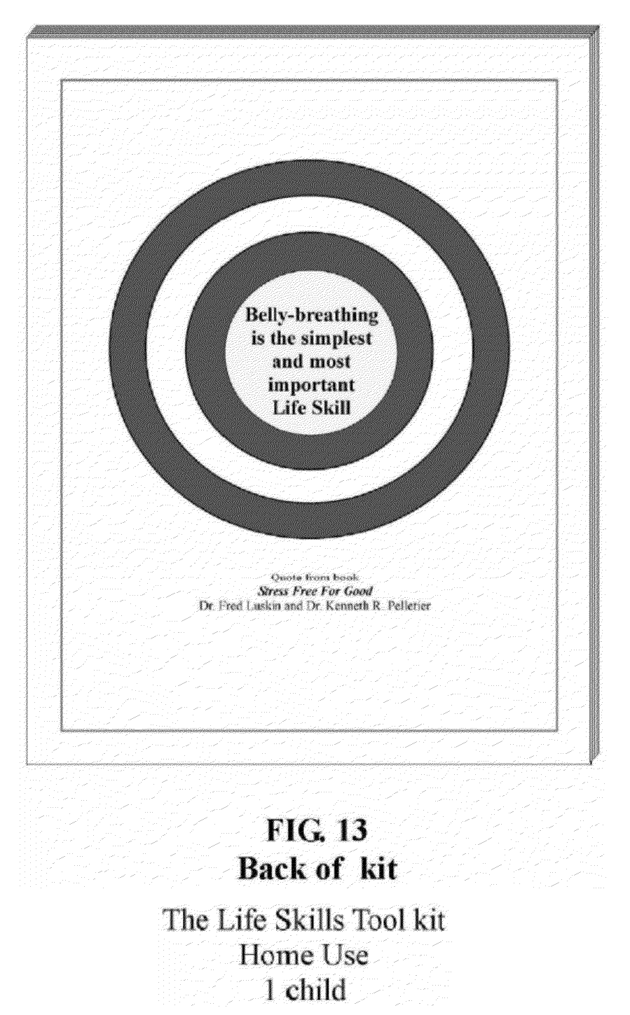

FIG. 13 is a back view of kit package 1 per child, at home use; quote from book Stress Free For Good by Dr. Fred Luskin and Dr. Kenneth R. Pelletier. Although the invention has been described and illustrated with a certain degree of particularity, it is understood that the present disclosure has been made only by way of example, and that numerous changes in the combination and arrangement of parts can be resorted to by those skilled in the art without departing from the scope of the invention, as hereinafter claimed.

1. A method for shaping the behavior of a child and creating a new habit, comprising:
providing multi-media, indicia and instructions for teaching the steps of:
showing the child an instructional DVD;
affixing prohibitory indicia to walls or doorways;
giving the child coloring sheets, stickers and reward cards at the appropriate time,
reminding the child and the caregiver to role play to learn a new habit or behavior until the child can do this for one's self and to stop and think before acting/reacting, and further including
teaching a child to self regulate when he/she encounters a set issue or problem learned via the multi-media and material provided.

2. The method of claim 1, wherein the multi-media, indicia and instructions further include:
providing to the child life skills development information included on indicia and a series of twelve key life skills in an age appropriate instructional DVD format;
instructing the caregiver to have the child view and listen to the instructional DVD which is in a storybook format and includes a narrative storyteller as well as puppets, animation and music video;
instructing the caregiver to explain and make sure the child is doing the mental and physical exercises correctly per the DVD story, exercise and music video;
repeatedly showing the instructional DVD with the story, exercise and music video to the child, until the child can repeat how to do the exercise for him/her self, and learns a new behavior.

3. The method of claim 1, wherein the multi-media, indicia and instructions further include:
presenting a correlating exercise and having the child practice the correlating exercise, viewing a poster, coloring a matching character lesson coloring sheet,
instructing the child to listen, learn, practice and own new habits and behaviors presented in the child life skills development information so as to reduce stress to the child when coming up against this practiced life skill.

4. The method of claim 1, wherein the multi-media, indicia and instructions further include indicia included in a kit to hand out to the child, while instructing the caregiver to post colored coloring sheets in classroom, let the child wear the sticker on his or her person and carry the reward card to use as a reminder tool, the reward card having an image character on one side and the how to step of the lesson plan of learned life skill on the other side; wherein indicia is further included in the kit for the caregiver to post in the child's view.

5. The method of claim 1, wherein the multi-media, indicia and instructions further include: indicia included in a kit for the caregiver consisting of instructional sheets and practice boards each relating to twelve different life skills.

6. (canceled)

7. (canceled)

8. An instructional kit for shaping behavior of a child and creating a new habit, comprising:
multi-media, indicia and instructions including a child instructional DVD;
prohibitory indicia suitable for affixing to walls or doorways;
child coloring sheets, stickers and reward cards;
instructions for role playing to learn a new habit or behavior until the child can do the new habit or behavior for his or herself and to stop and think before acting/reacting, and
instructions for teaching a child to self regulate when he/she encounters a set issue or problem learned via the multi-media and material provided.

9. An educational multi-media method, including:
printed materials for conveying life skills development information from a caregiver to a child to listen, learn, practice and own new habits and behaviors, including a series of twelve key life skills in an instructional DVD format.

10. The method of claim 9 further comprising:
having the child view and listen to the instructional DVD content which is age appropriate and in a storybook format, and includes storytellers, puppets and limited animation.

11. The method of claim 9 further comprising:
having a caregiver explain the lesson on how to do the exercise per the story, repeating showing the instructional DVD with the exercise and music to the child until the child can repeat how to do the exercise for him/her self, presenting a correlating exercise and having the child practicing said exercise, and presenting a practice and own exercise with reinforcing music.

12. The method of claim 11 further comprising dispensing a recognition sticker after viewing the instructional DVD content and practicing the exercise.

13. The method of claim 9, further comprising handing out to the child an indicia character's coloring sheet and having the child coloring on the coloring sheet.

14. The method of claim 9, further comprising dispensing a reward card to the child after successfully completion of showing the caregiver the child has acquired said knowledge of the exercise.

15. The method of claim 9, further comprising posting on a hard surface like a wall, a reminder poster with indicia of a related character image in viewing distance for the child to be reminded of the lesson learned.

16. The method of claim 9, further comprising keeping score of the child's daily usage for three to six days.
